(19) United States
(12) Patent Application Publication
(10) Pub. No.: US 2011/0257997 A1
(43) Pub. Date: Oct. 20, 2011

(54) System and Method for Clinical Practice and Health Risk Reduction Monitoring

(76) Inventor: Brian Gale, Bronx, NY (US)

(21) Appl. No.: 12/905,980

(22) Filed: Oct. 15, 2010

Related U.S. Application Data
(63) Continuation-in-part of application No. 12/408,686, filed on Mar. 21, 2009.
Application No. 12/408,686 is a continuation-in-part of application No. 12/361,081, filed on Jan. 28, 2009.
(60) Provisional application No. 61/038,729, filed on Mar. 21, 2008.
(60) Provisional application No. 61/252,100, filed on Oct. 15, 2009.
(60) Provisional application No. 61/252,097, filed on Oct. 15, 2009.
(60) Provisional application No. 61/255,773, filed on Oct. 28, 2009.
(60) Provisional application No. 61/262,431, filed on Nov. 18, 2009.
(60) Provisional application No. 61/297,773, filed on Jan. 24, 2010.
(60) Provisional application No. 61/299,268, filed on Jan. 28, 2010.

(51) Int. Cl. G06Q 50/00; G06Q 10/00

(52) U.S. Cl. 705/3

(57) ABSTRACT

A System and Method for monitoring risk reduction activities in one or more medical practice settings and environments is described. The system automatically monitors communications and equipment to verify proper clinical treatment processes and activities that reduce the risk of poor clinical outcomes or increased risk to health. The system can also automatically monitor out-patient activities. Clinical activities are monitored and various rules and risk reduction metrics calculated from the data. Real-time monitoring further permits alarms to be triggered if certain clinical steps considered proper are not followed in a particular case.

### PRIORITY CLAIM

This application claims priority to and herein incorporates by reference in their entirely U.S. Provisional Patent Application No. 61/252,100 filed on Oct. 15, 2009; U.S. Provisional Patent Application No. 61/252,097 filed on Oct. 15, 2009; U.S. Provisional Patent Application No. 61/255,773 filed on Oct. 28, 2009; U.S. Provisional Patent Application No. 61/262,431 filed on Nov. 18, 2009; U.S. Provisional Patent Application No. 61/297,773 filed on Jan. 24, 2010; U.S. Provisional Patent Application No. 61/299,268 filed on Jan. 28, 2010;

and is a Continuation in Part to U.S. Patent Application No. 12/408,686, filed on Mar. 21, 2009 which further claims priority to both provisional application 61/038,729, filed on Mar. 21, 2008 and as a continuation in part to U.S. Patent Application No. 12/361,081, filed on Jan. 28, 2009.

### SUMMARY OF THE INVENTION

Background: Failure to communicate and failure to diagnose are leading causes for patient injury and malpractice actions in the United States. The former cause is increasing in frequency. The Joint Commission hospital accreditation organization has made Critical Test Reporting a priority in its National Patient Safety Goals. Court rulings now indicate that reporting physicians (who perform diagnostic procedures and provide consultations) may have a duty to communicate critical findings to referring clinicians as well as patients and from clinicians themselves to patients.

The advent of electronic medical records (EMR) enables physicians and health care facilities to document health care activity with increasing precision and reliability. Health care workers perform many activities which reduce their malpractice liability risk. This can have financial benefits, for healthcare providers, facilities and for the malpractice insurers who cover each health care institution, respectively. These carriers can benefit from documentation that covered health care institutions and providers perform risk reduction activities. Examples include (but are not limited to) medication reconciliation, critical test result notification and response, and hand washing.

Medication errors are an increasing source of morbidity (patient injury), mortality and malpractice actions in the United States. Medication reconciliation is a process whereby physicians document and evaluate the medications a patient currently takes, and reconcile proposed therapy accordingly. This reduces the risk of adverse drug interactions. The Joint Commission has made Medication Reconciliation a priority in its National Patient Safety Goals.

Compliance data and metrics are useful to lower the risk of malpractice claims and injury. For example, see U.S. patent application Ser. No. 12/408,686, filed on Mar. 21, 2009, which is incorporated herein by reference.

Value-based insurance policies are priced according to risk. Pricing can be varied by premium price, discount, allowances to install risk reduction equipment or to undergo training, or a combination. This invention transmits data documenting and transmitting insured customers' risk reduction activities, in some cases as they are undertaken, to insurance companies. This includes automatically collected data that verifies that the risk reduction activities are taking place. Insurers can then use these data to accurately gauge each customer's liability risk. In addition, failure to communicate and failure to diagnose are leading causes for medical malpractice actions in the United States. The former cause is increasing in frequency. The Joint Commission for Hospital Accreditation has made Critical Test Reporting a priority in its National Patient Safety Goals. Court rulings now indicate that reporting physicians (who perform diagnostic procedures and provide consultations) may have a duty to communicate critical findings to referring clinicians as well as patients. By automatically verifying the operation and use of communication systems for delivery of critical test results, insurance companies can monitor this type of risk reduction activity.

There are additional areas where automatic verification of risk-reduction activities can be performed. Health care workers perform many activities which reduce their malpractice liability risk. The advent of electronic medical records (EMR) enables physicians and health care facilities to document health care activity with increasing precision and reliability. This can have financial benefits, for the malpractice insurers who cover health care institutions. These carriers can benefit from documentation that covered health care institutions and providers perform risk reduction activities. Examples include (but are not limited to) medication reconciliation, critical test result notification and response, and hand washing. The institutions and practitioners that document risk reduction activity are less expensive to insure. Moreover, insurers can profit by offering a portion of the risk reduction to the customers as a discount.

In some cases, the data being entered into the electronic medical records or the operation of diagnostic exam request and test result creation and delivery is compromised by a lack of prompt attention to incoming or outgoing messages. In another embodiment, the invention applies data integrity rules to check that as participating users of the system send or receive test result message, or enter data into medical records, the timing of such activities meet a predetermined threshold of promptness associated with the diagnosis. This way the integrity of the message data and timing of communication is not compromised and may be relied upon for monitoring risk reduction activities or activities that are elevating risk.

### BRIEF DESCRIPTION OF THE DRAWINGS

FIG. 1: Flow chart presenting steps for a critical test result monitoring systems that tracks critical communications residing in medical records, stores and converts the communications into data and transmits to interested institutions and/or agencies.

FIG. 2: Flow chart presenting steps for a monitoring system that tracks outpatient status and records and transmits performance data to interested institutions and/or agencies.

FIG. 3: Flow chart presenting steps for a database warehouse system that allows user's to access documentation of risk reduction activity in electronic medical records and other electronic databases.

FIG. 4: A description of the open source system that converts database records into documents from Mirza Kashif located at http://groups.google.com/group/googleris/web/using-google-desktop-to-create-ris-search-engine.

FIG. 5: Another description of the open source system that converts database records into documents from Mirza Kashif located at http://groups.google.com/group/googleris/web/using-google-desktop-to-create-ris-search-engine.

FIG. 6: Diagram of data communications in a healthy activities network schematic.

FIG. 7: A screenshot of a webpage listing versions of Health Level Seven (HL-7). HL-7 is a set of standard data formats for clinical data.

FIG. 8: A screenshot of a webpage listing Integrated Health Enterprise (IHE) protocols.

FIG. 9: A screenshot of the International Organization for Standardization website listing HL-7 formats and protocols.

FIG. 10: A screenshot of the International Organization for Standardization website displaying a detailed page result view for HL-7 version 3.

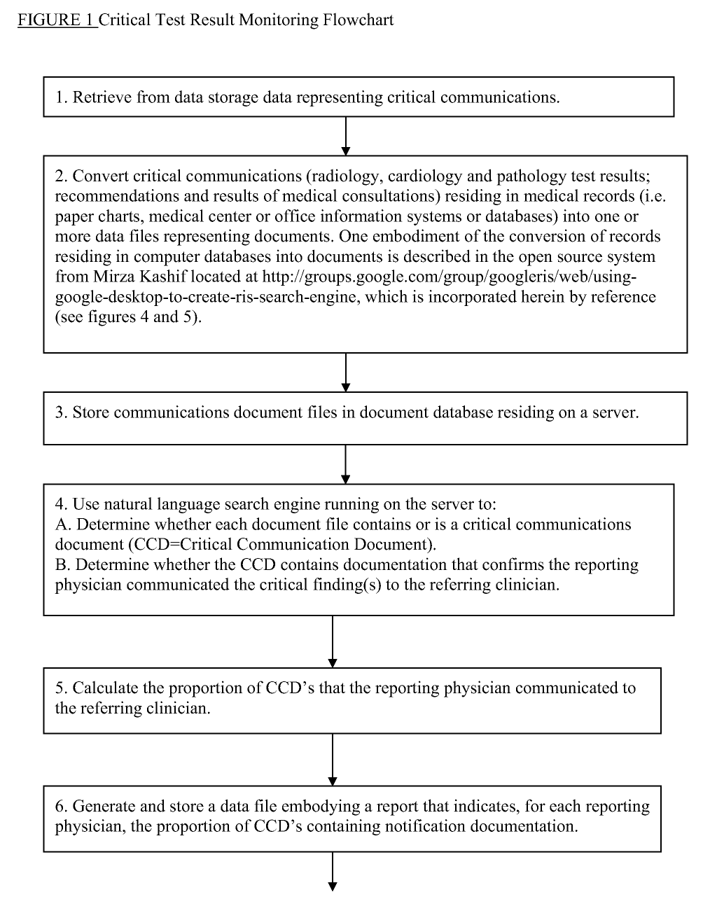

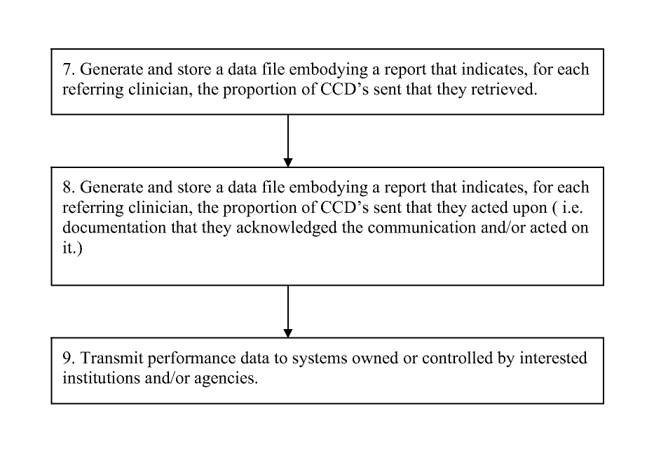

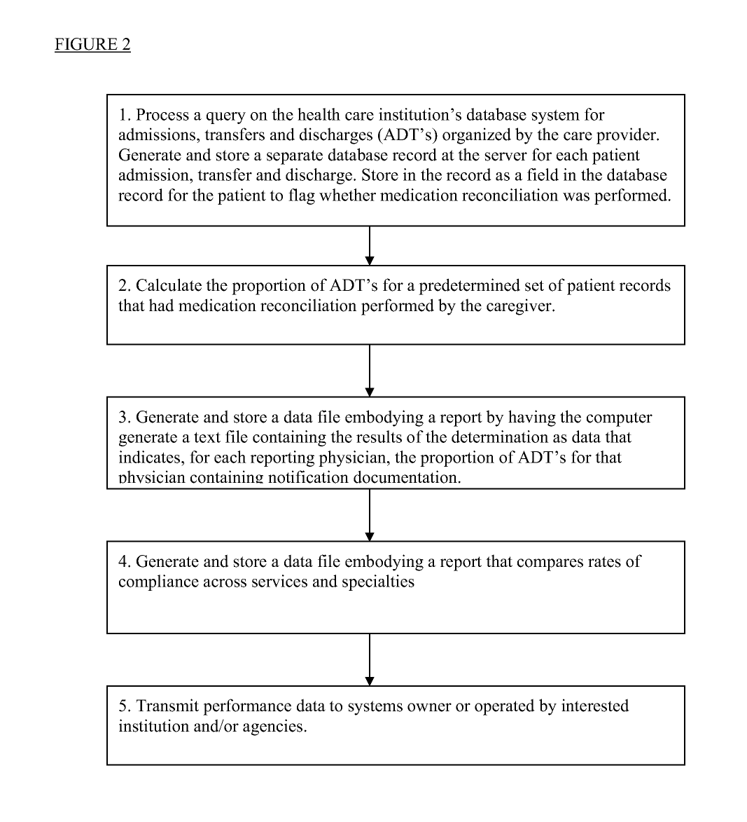

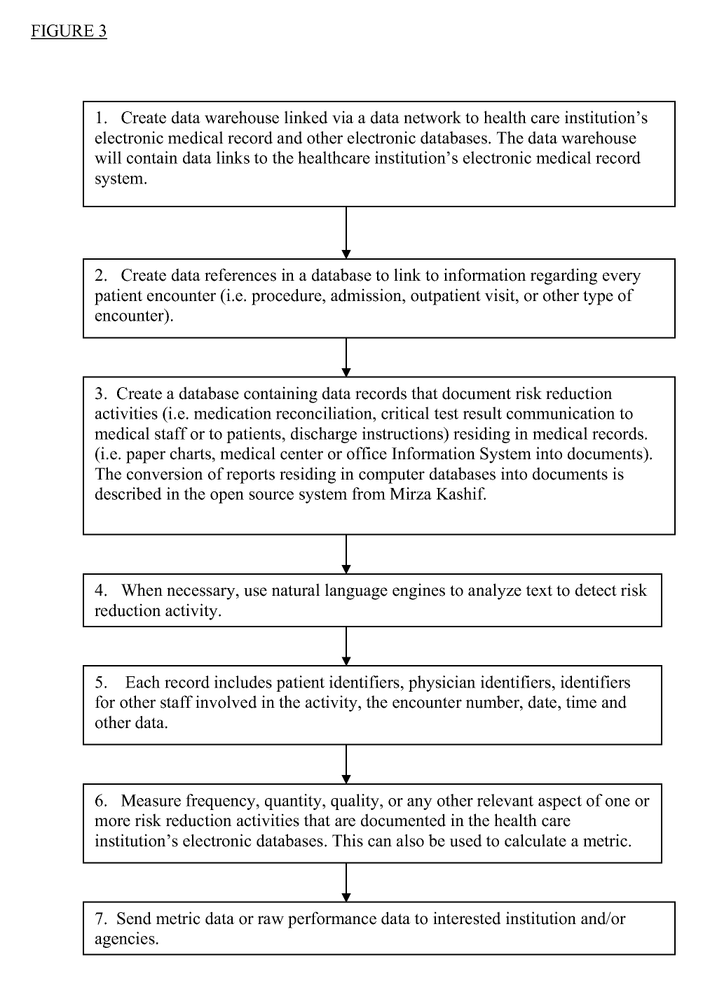

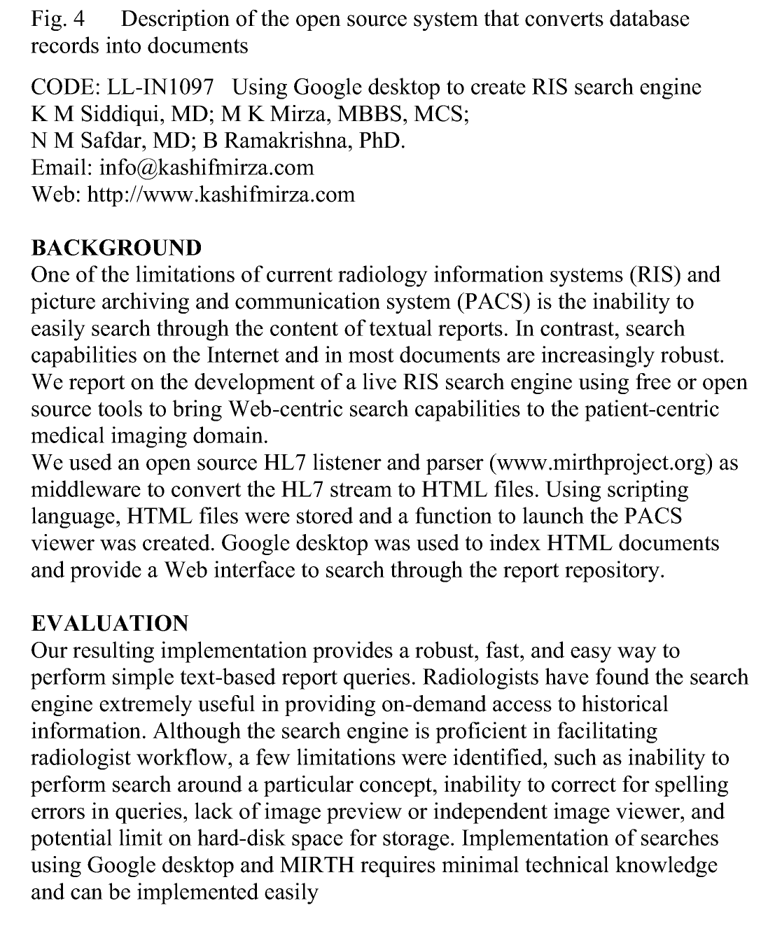

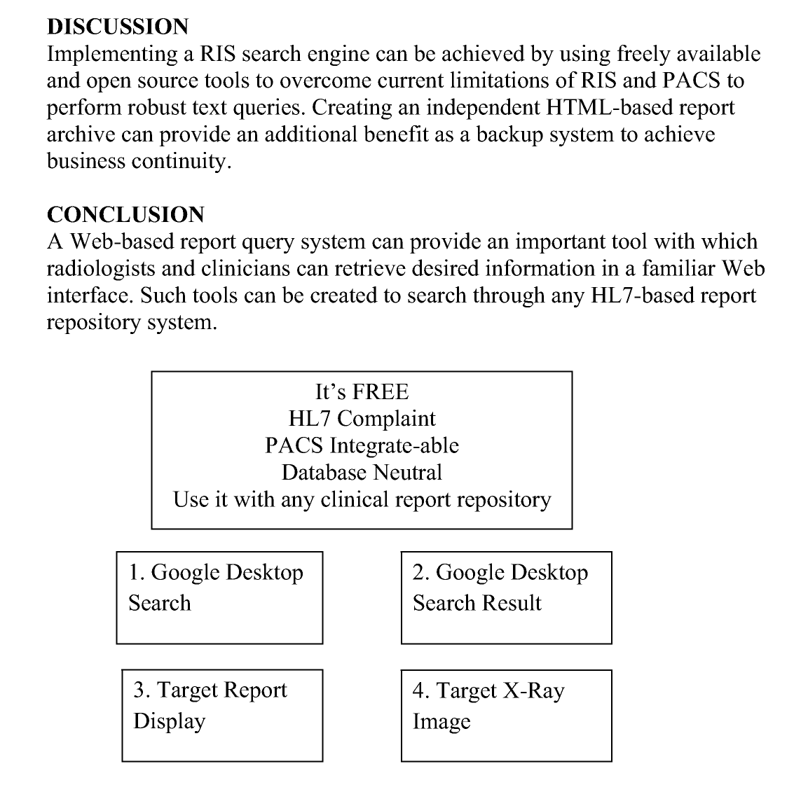

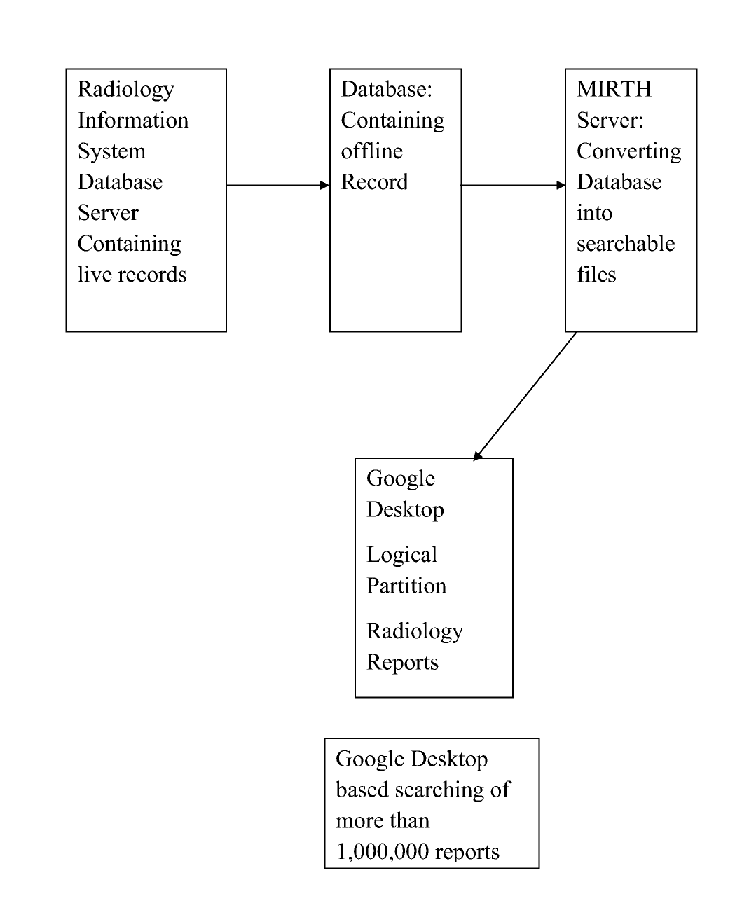

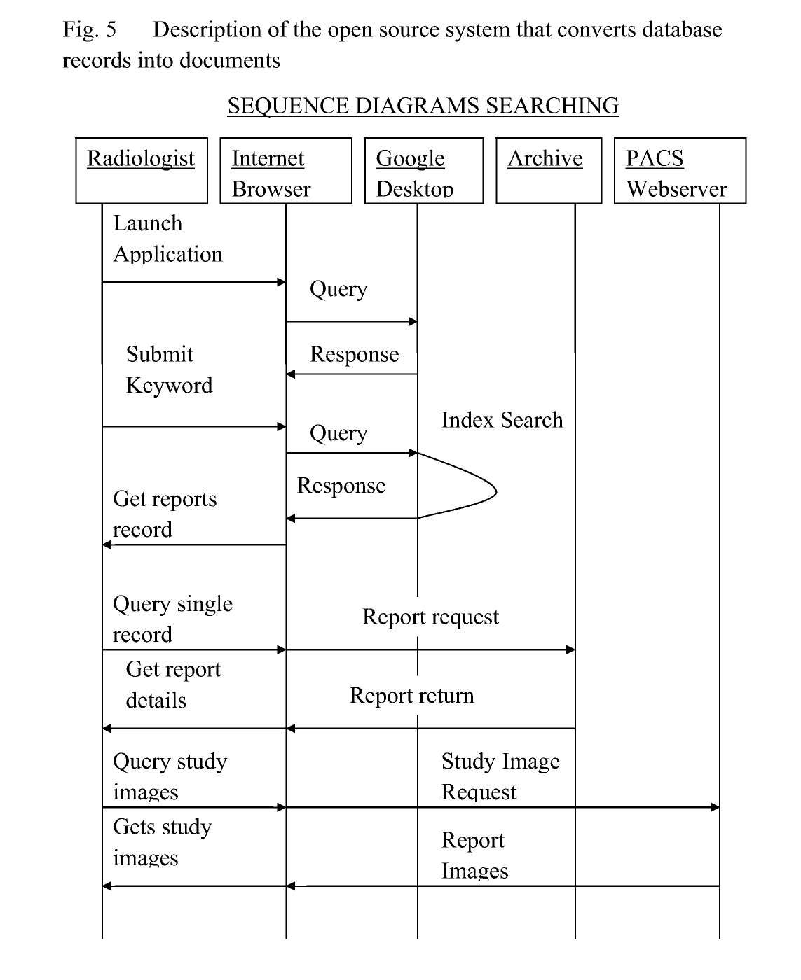

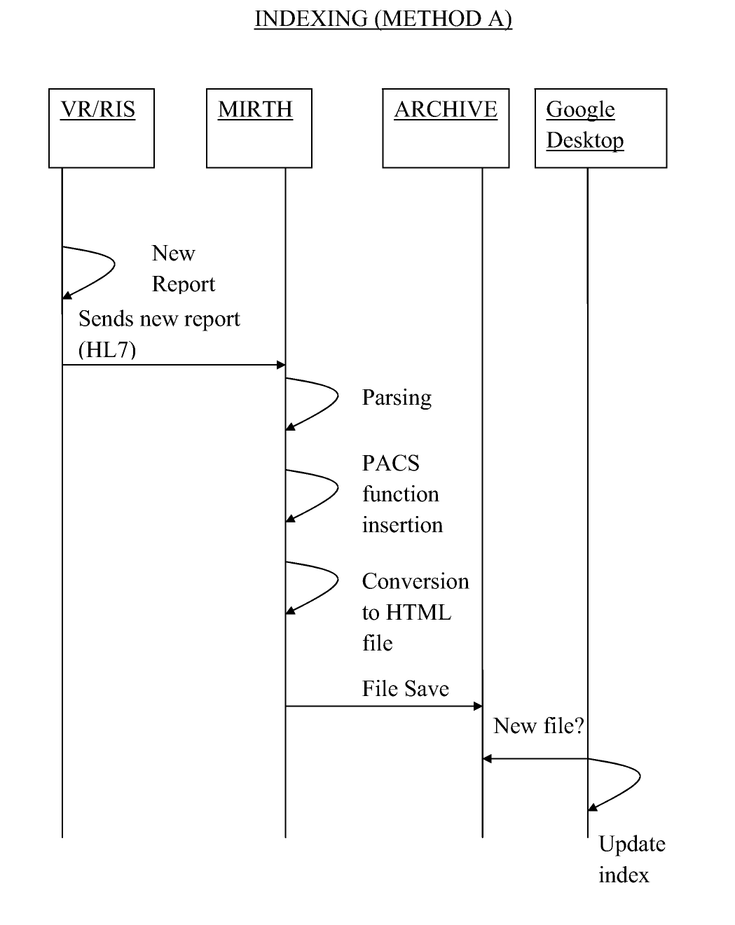

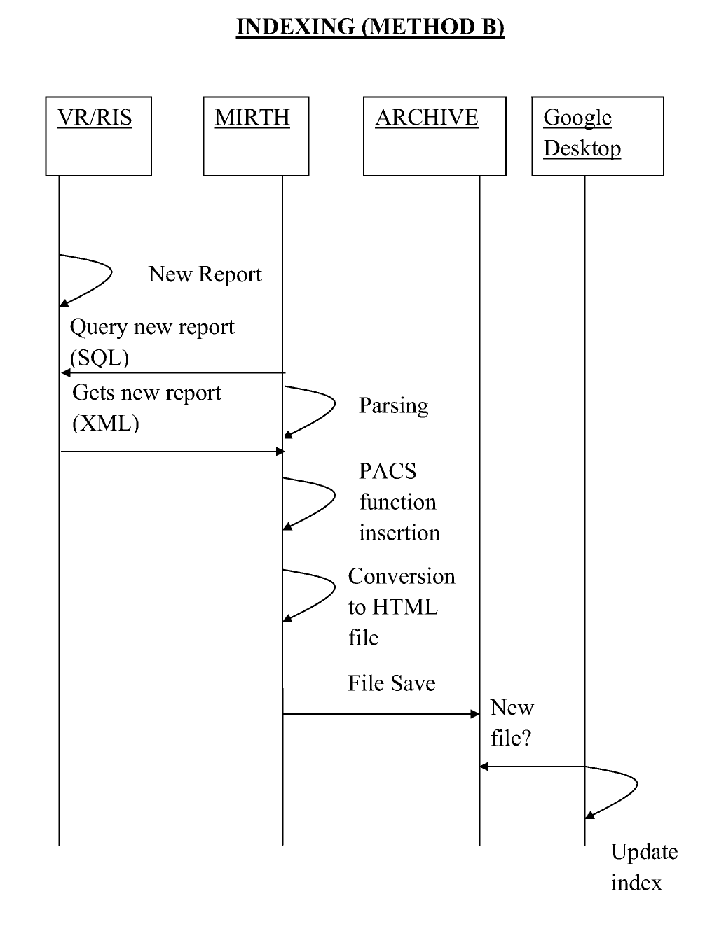

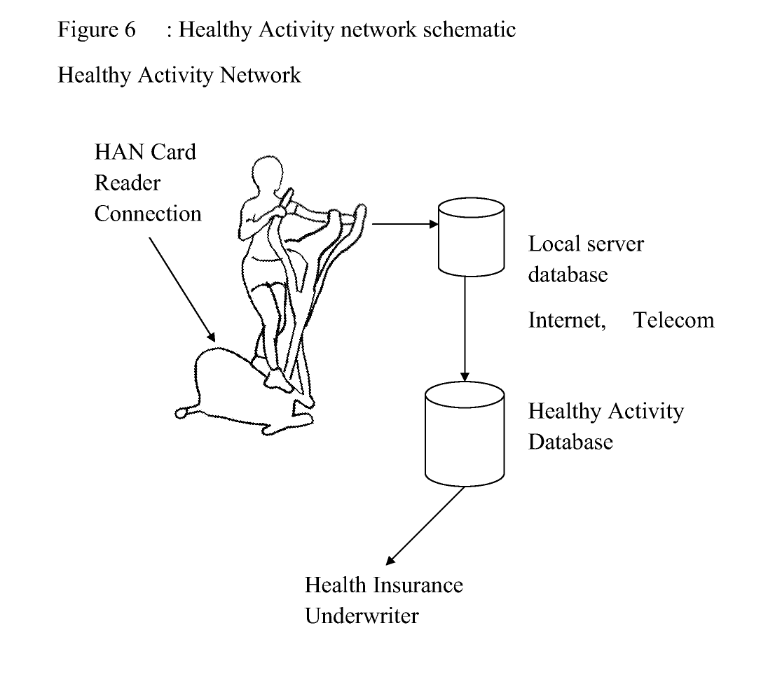

### DESCRIPTION OF THE PREFERRED EMBODIMENTS

Critical test reporting systems and risk mitigation systems are disclosed in U.S. patent applications Ser. No. 12/408,686, filed on Mar. 21, 2009, 61/252,100 filed on Oct. 15, 2009, 61/252,097 filed on Oct. 15, 2009, 61/262,431 filed on Nov. 18, 2009 and 61/297,773 filed on Jan. 24, 2010 all of which are incorporated herein by reference.

One embodiment of the invention performs the following functions:
1. Document the frequency with which diagnostic physicians and clinical labs communicate diagnostic test results or other critical results (i.e. results and recommendations of medical consultations) to referring clinicians and to patients; document successful communication of reportable test results, for example, the referring clinician received the data.
2. Document how frequently healthcare providers perform other risk reduction activities.
3. Communicate data to malpractice insurers, accreditation agencies, other interested agencies or used internally by healthcare institutions and for other management purposes.
4. Determine metrics from the data that can include a metric to correlate to healthcare providers level of safety activity, for example, control chart trendings, volume of activity, 1 tailed T tests or 2 tests that demonstrate the practitioner's safety activity relative to their peers.

In another embodiment of the invention a system performs to document the how frequently medical providers perform medication reconciliation when they admit patients to healthcare institutions. These data can be reported to malpractice insurers, accreditation agencies, other interested agencies or used internally by healthcare institutions for management purposes. The metric determinations described above may be used with medical reconciliation data.

In the another embodiment for Critical Test Result notification metric reporting, there is software running on a computer that is part of a computer system. The computer, when running the software will execute a process. The process steps comprise:
1. Retrieve from data storage data representing critical communications or data that is subject or should be or will be subject to a communication. Data storage may be part of the computer server or operatively connected to it as a mass storage device available over a network. Data may be stored remotely on a Regional Health Information Organization (RHIO) or other similar system and accessed over a data network.
2. Convert critical communications (radiology, cardiology and pathology test results; recommendations and results of medical consultations) residing in medical records (i.e. paper charts, laboratory medical center or office information systems, EMR or diagnostic test result databases) into one or more data files representing documents or data records in a database. One embodiment of the conversion of records residing in computer databases into documents is described in the open source system from Mirza Kashif located at http://groups.google.com/group/google-ris/web/usinggoogle-desktop-to-create-ris-search-engine, which is incorporated herein by reference
3. Store communications document files in document database residing on a server.
4. Use natural language search engine or other searching technique running on the computer to:
   A. Determine whether each document file contains or is a critical communications document (CCD=Critical Communication Document) In this application “Critical Communication” would include any result that is reportable or should be reported, whether or not the level of urgency is considered “critical” at a particular time.
   B. Determine whether the CCD contains documentation that confirms the reporting physician communicated the critical finding(s) to the referring clinician.
5. Calculate the proportion of CCD's that the reporting physician communicated to the referring clinician.
6. Generate and store a data file embodying a report that indicates, for each reporting physician, the proportion of CCD's containing notification documentation. In another embodiment the additional step of: 6.1 automatically generating a list of referring clinicians, or from the referring clinician field for all of the diagnostic test reports. This can be generated from the database records of critical result notifications. In one embodiment, a data field in the record lists the name of the referring health care provider. The list of notified referring providers may be used to calculate a metric regarding their compliance to malpractice insurers, certification agencies, other interested entities, or by the health care institution itself. In one embodiment, the result message to the referring physician may be matched against some action taken by the referring physician, or simply whether the referring physician retrieved the message.
7. Generate and store a data file embodying a report that indicates, for each referring clinician, the proportion of CCD's sent to them that they retrieved.
8. Generate and store a data file embodying a report that indicates, for each referring clinician, the proportion of CCD's sent that they acted upon (i.e. documentation that they acknowledged the communication and/or acted on it).
9. Transmit performance data to systems owned or controlled by interested institutions and/or agencies. Transmission may be accomplished by an automatically generated email, FTP (File Transfer Protocol) or any other means of moving digital data from one system to another. The transmission may be the result of a request by such interested institution or agency that is submitted to the computer system. In another embodiment, the system automatically transmits the data at predetermined times.
10. Used in another embodiment is this step: Health Care provider Dashboard. This is a graphical user interface that is displayed on a user's computer screen. The program that actuates the display receives performance data from other software modules. The display presents in near real-time personal risk metric data for both reporting health care providers and referring health care providers. Features include:
   Notifications metrics, presented for the organization, broken down by specialty using color coding or by physician.
   Rate of critical test result notification retrieval and retrieval intervals and metrics, presented for the organization, broken down by specialty using color coding or by physician.
   Notifications can be listed by:
      status (retrieved vents pending)
      diagnostic facility (i.e. laboratory, imaging center, hospital)
      reporting provider (i.e. notifying lab, radiologist, pathologist, cardiologist)
   Open Notifications List, which lists the actual notifications that have been sent but not retrieved by the referring physician.
   A button or other interface mechanism actuating subscription enrollment in SaferMD or some other risk reduction certification agency that verifies metrics or generates metrics regarding risk reduction activities.
   A button or other interface mechanism actuating an electronic authorization to pass data through third party clearing house or data certifier, such as SaferMD or some other risk reduction certification agency.

Step 2 of this embodiment an be implemented in various ways. For example, where information resides in text data comprising email traffic, the software embodying the invention, will, when running on a computer, request data files that represent the email messages. The software will parse the email data to find who the sender, receiver, subject and contents of the message. In one embodiment, keyword searching can be used to determine what type of message the email was. The software will generate a database record that indicates when the message was sent, when it was received, the sender, the recipient and the subject matter. In another embodiment, the software interfaces with a database that holds certain patient diagnostic data. The software will, when running, format requests and submit them to the database in accordance with typical database languages, for example, SQL. The database will return results that the software then uses to tabulate the information in the form it uses it. In this embodiment, the critical communications may have a relevant flag in a data field, for example identifying the message as a test result. In yet another embodiment, the software can parse data files that are contain text in repetitive patterns or fields, in order to populate a database with the relevant information.

In another embodiment, a healthcare institution's database can be mined for information to determine how well the institution is following proper clinical procedures.

The process steps are:
1. Process a query on the health care institution's database system for admissions, transfers and discharges (ADT's) organized by the care provider. Generate and store a separate database record at the server for each patient admission, transfer and discharge. Store in the record as a field in the database record for the patient to flag whether medication reconciliation was performed.
2. Calculate the proportion of ADT's for a predetermined set of patient records that had medication reconciliation performed by the caregiver.
3. Generate and store a data file embodying a report by having the computer generate a text file containing the results of the determination as data that indicates, for each reporting physician, the proportion of ADT's for that physician containing notification documentation.
4. Generate and store a data file embodying a report that compares rates of compliance across services and specialties
5. Transmit performance data to systems owned or operated by interested institution and/or agencies.

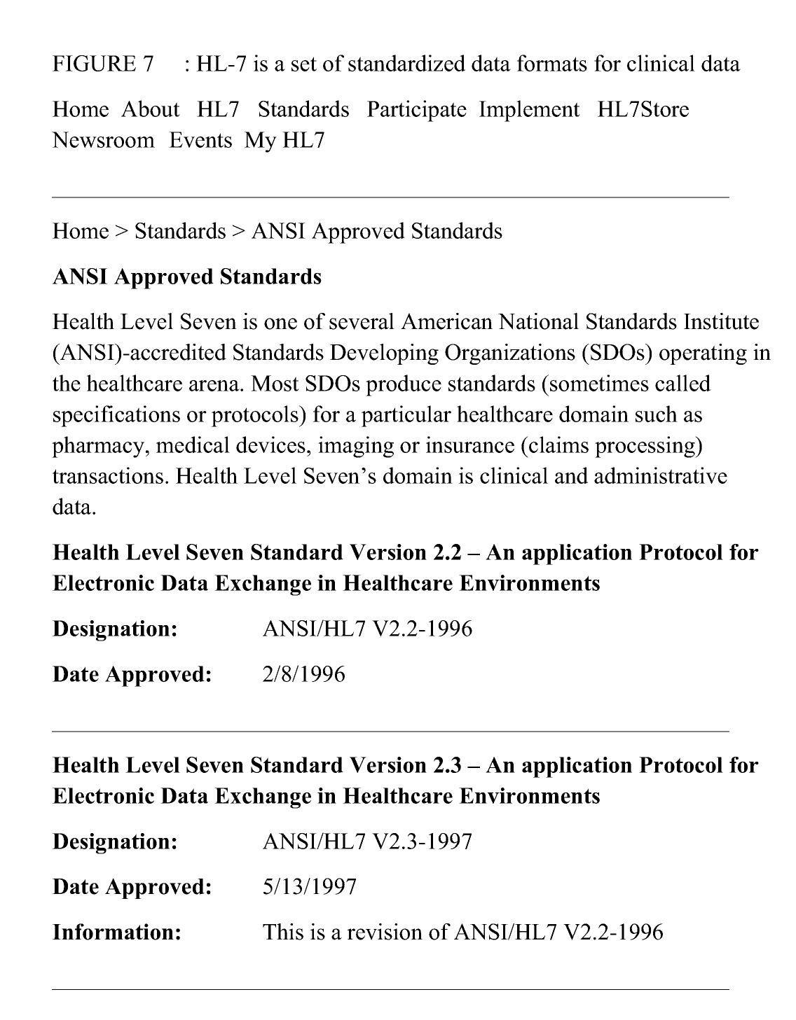

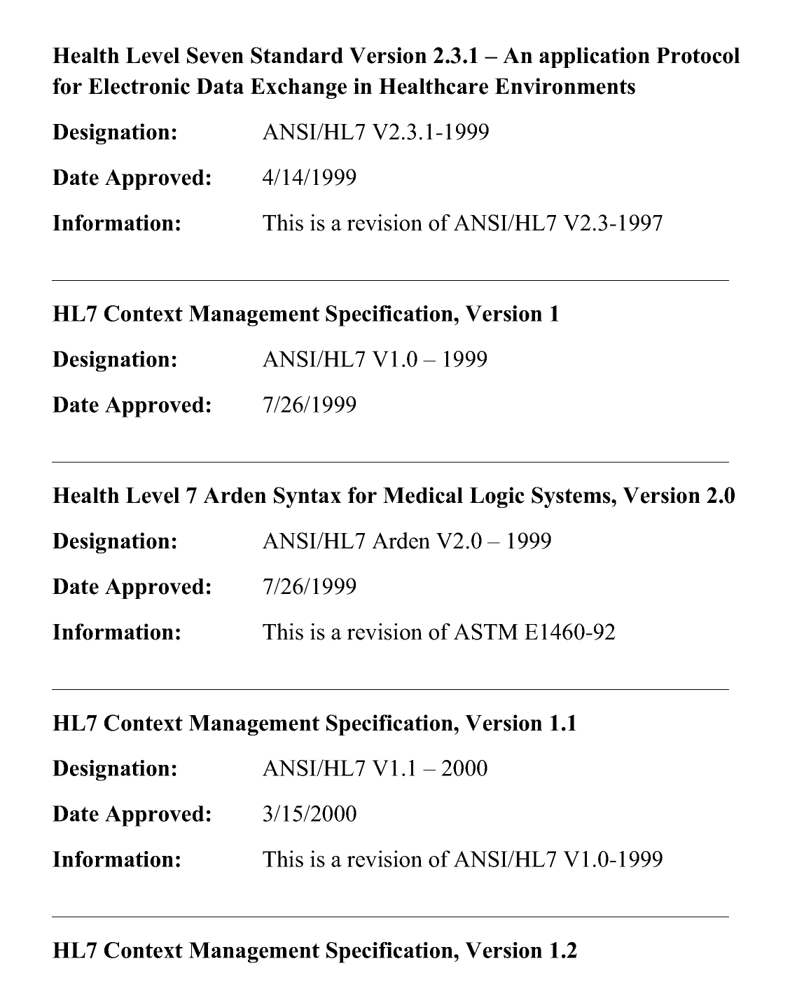

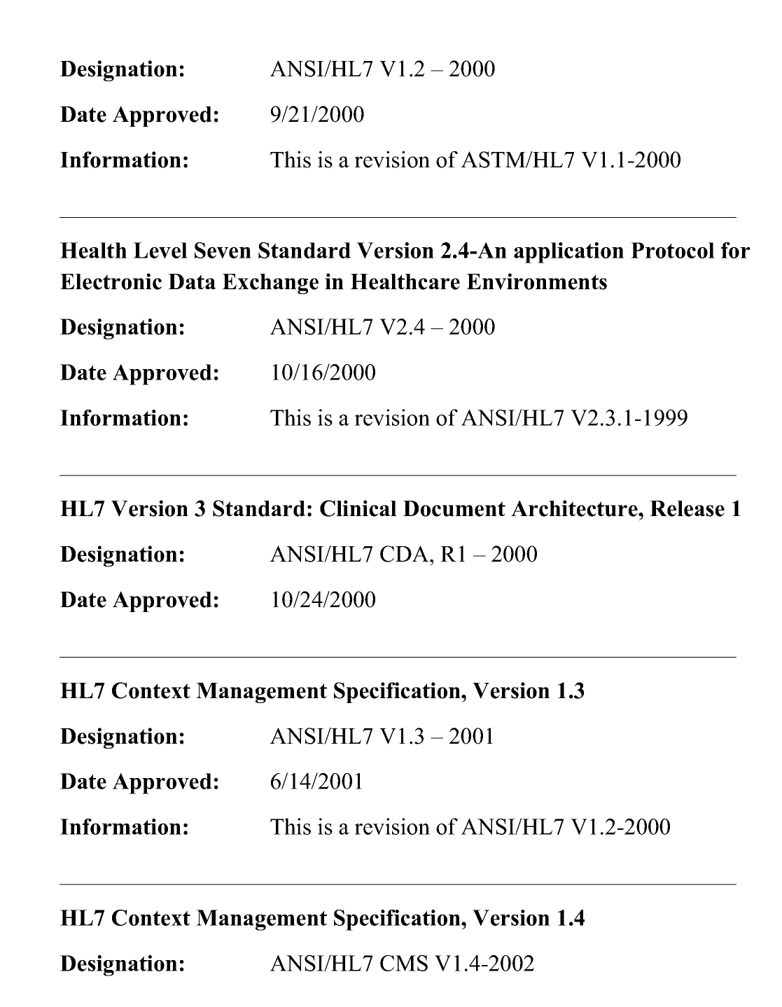

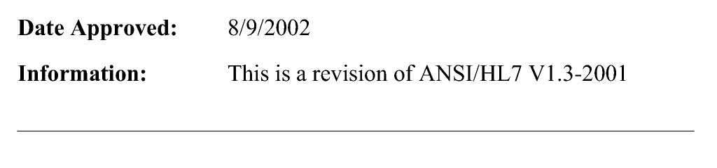

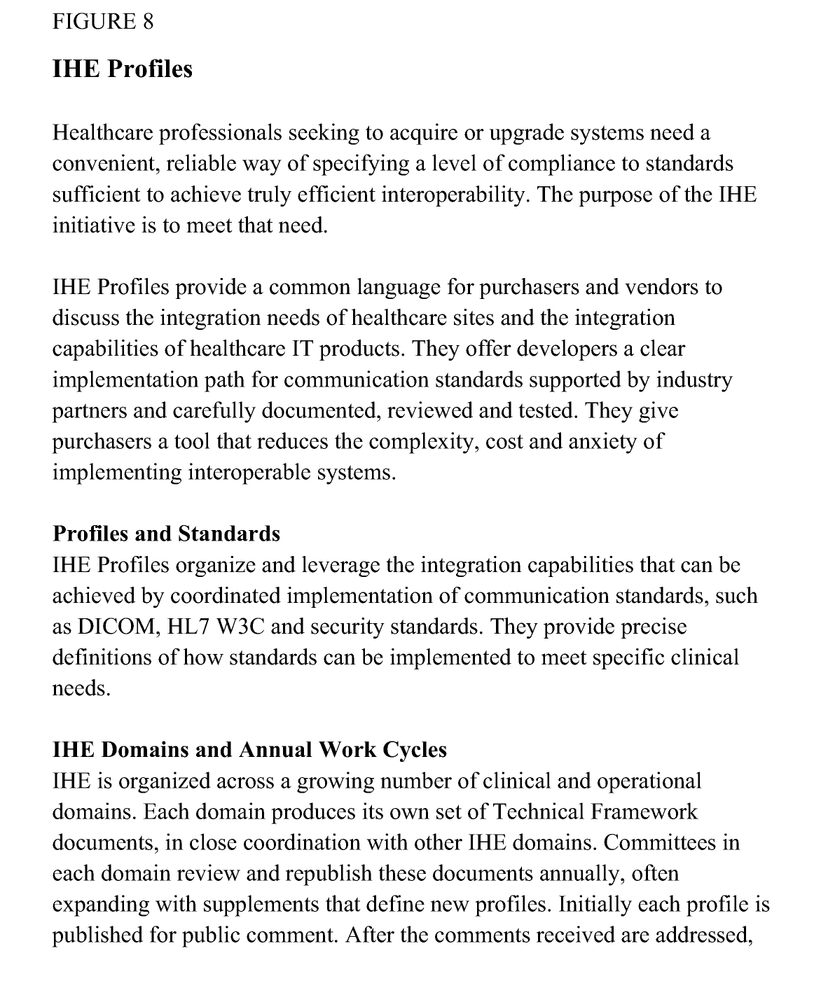

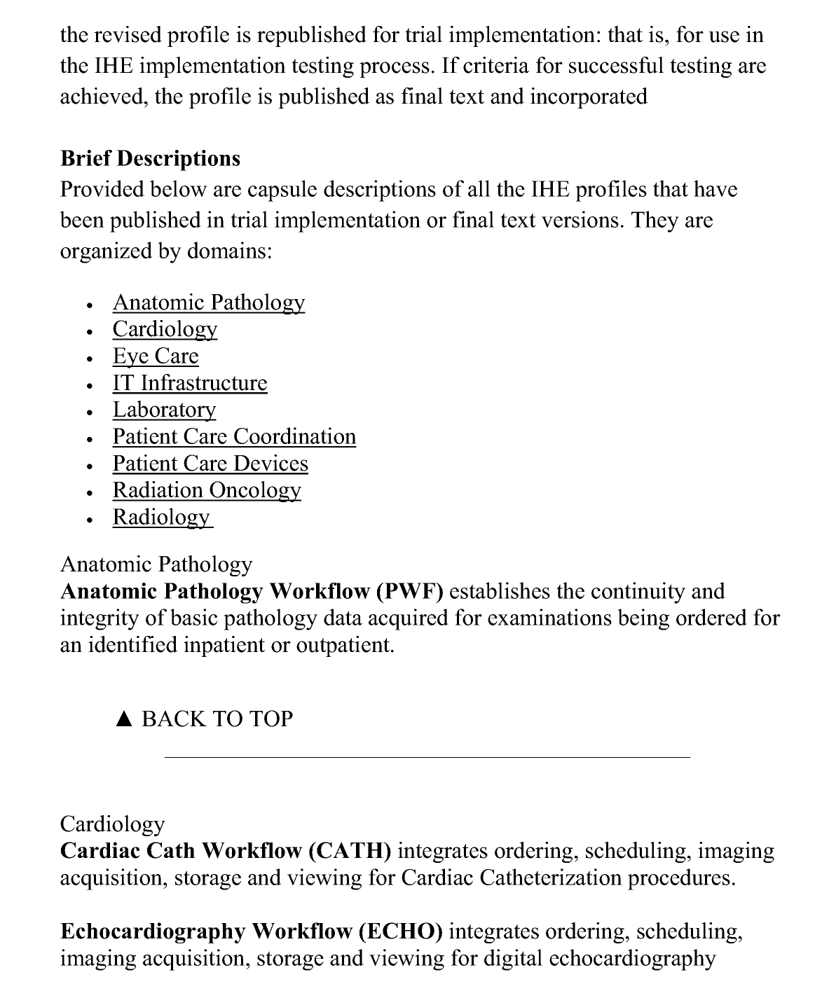

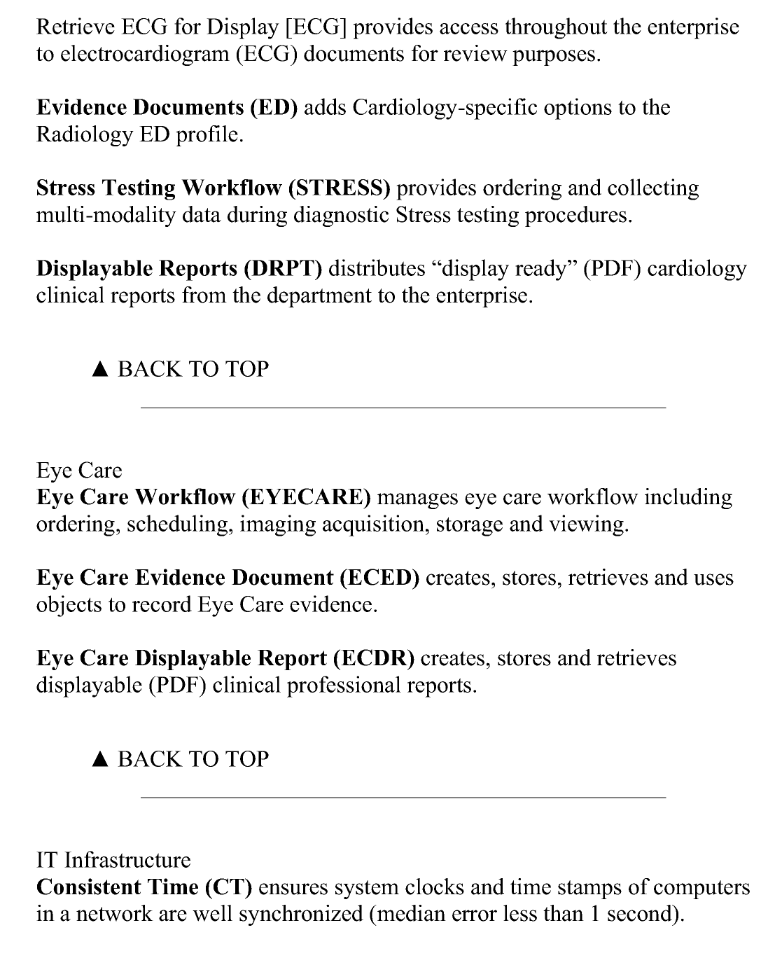

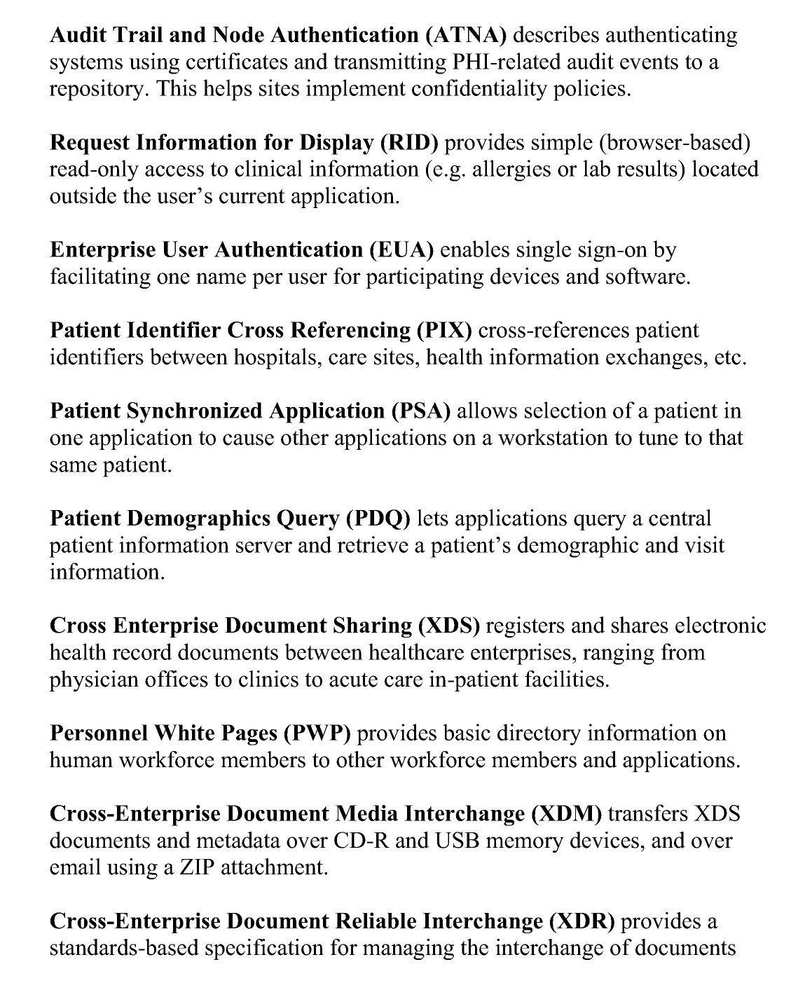

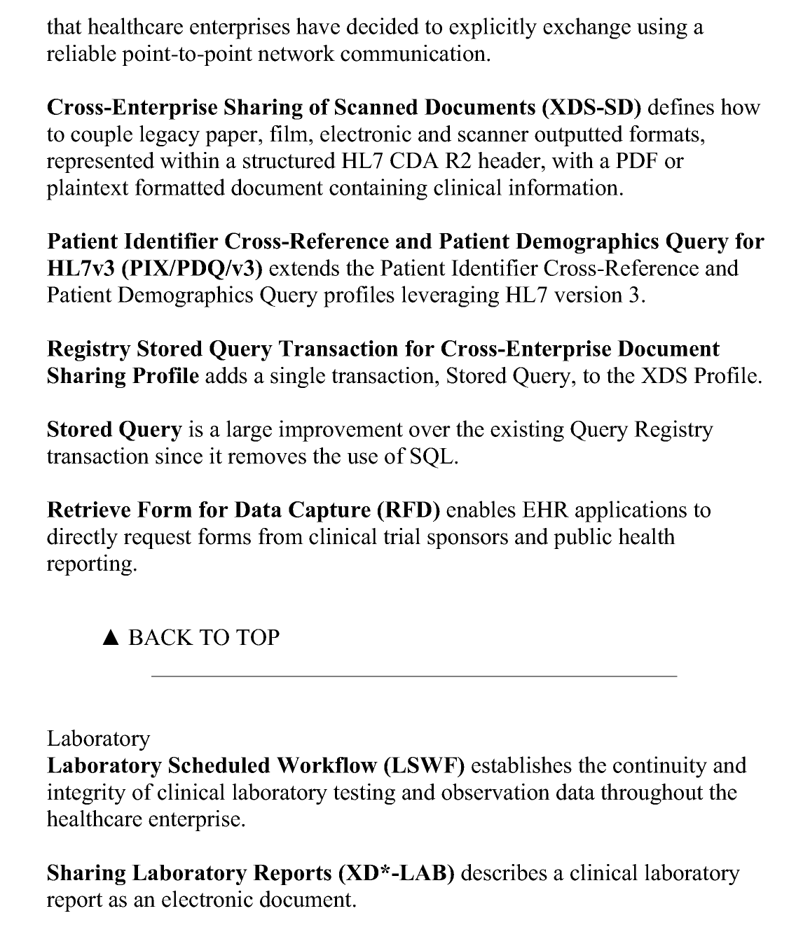

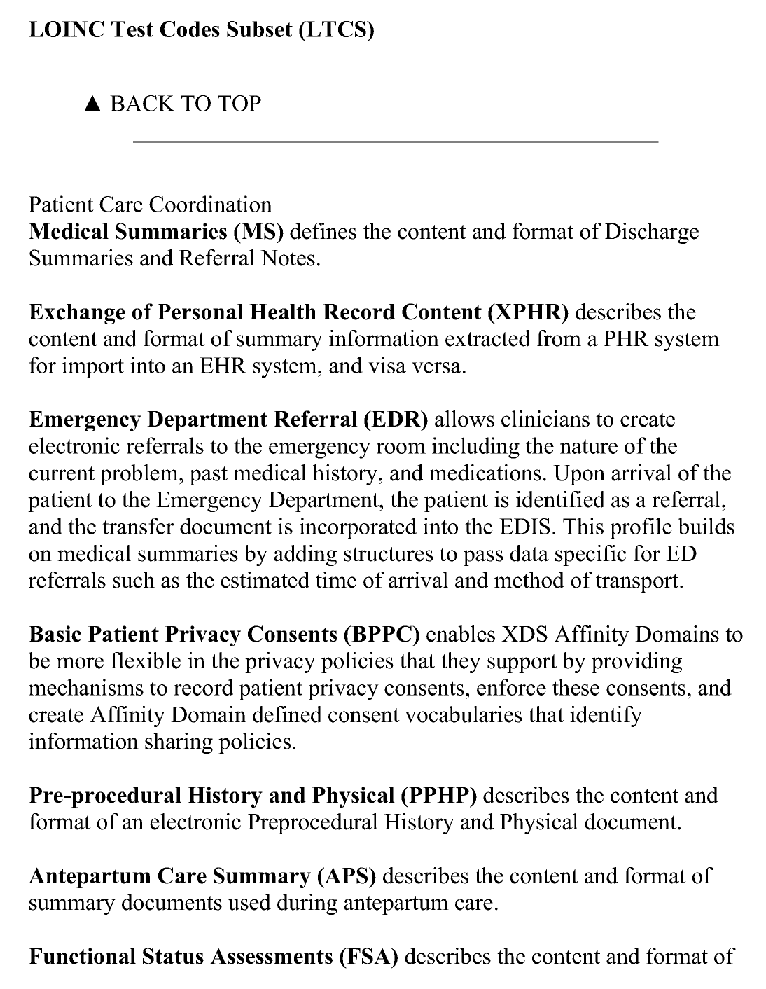

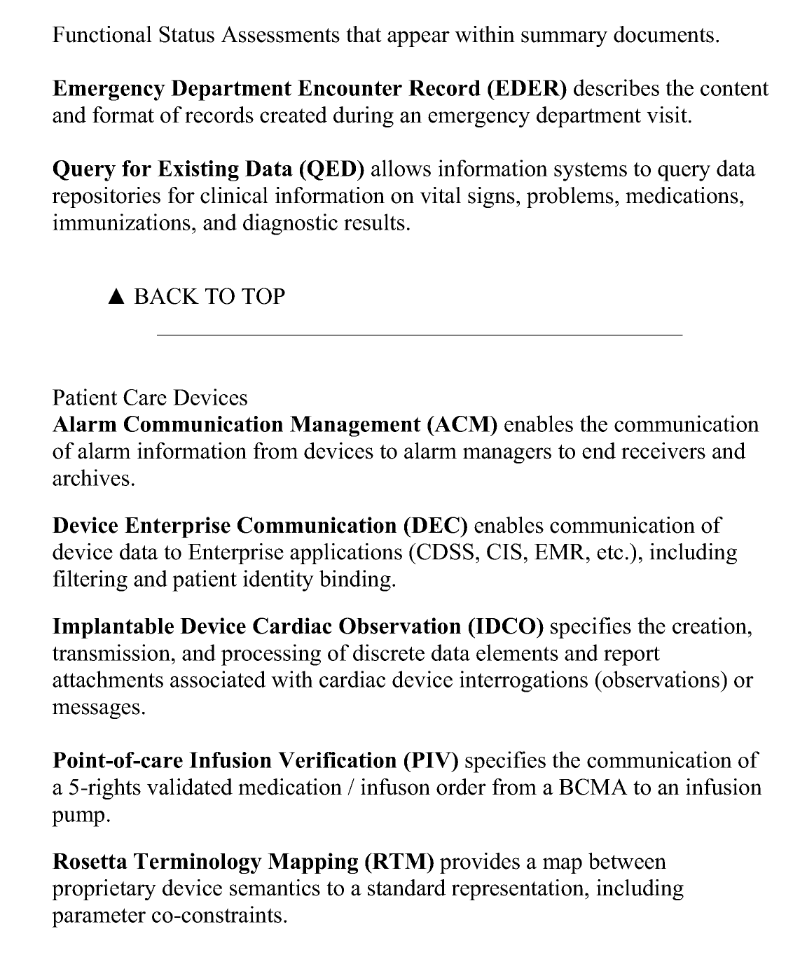

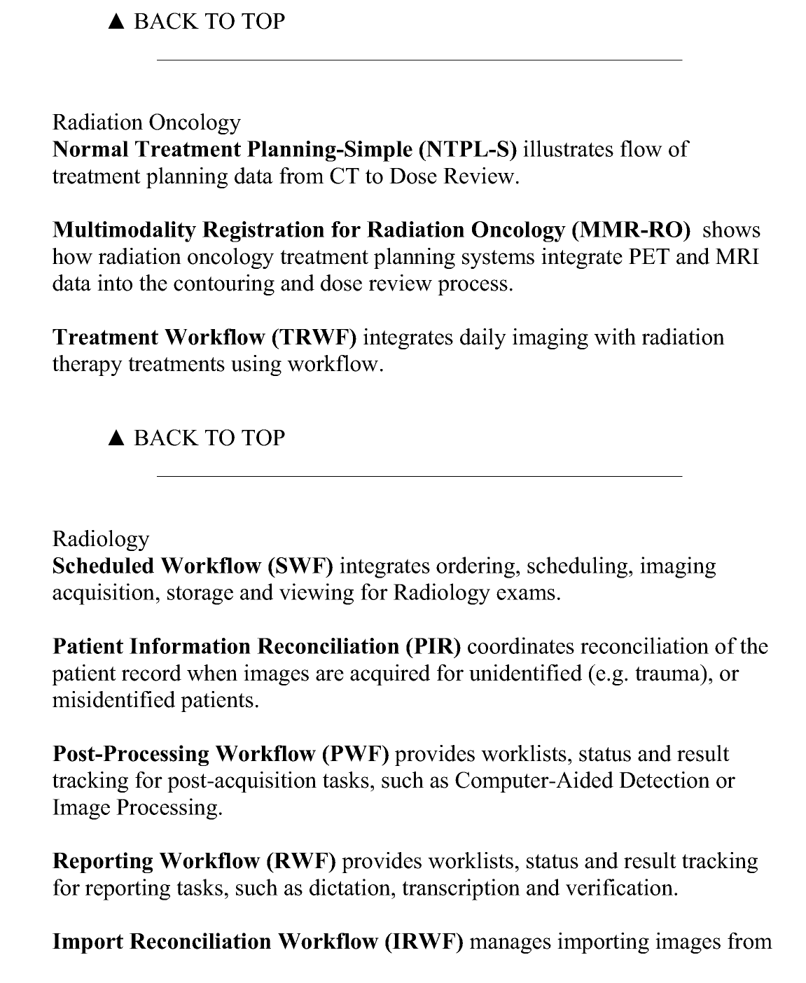

In another embodiment, the steps include:
1. Create data warehouse linked via a data network to health care institution's electronic medical record and other electronic databases, including third party service providers of data management or data communications. The data warehouse will contain data links to the healthcare institution's electronic medical record system. By “link”, it is meant any kind of data addressing technique, including, hyperlinks, network drive addresses, directories, drive letters, IP addresses, record locators in a database and the like, whether individually or in combination. In another embodiment, one data warehouse can contain data links to multiple healthcare institutions' systems. In this case, the data warehouse will maintain the data securely and separately to avoid confusing data between the two institutions. In another embodiment, a database would contain links to specific fields within the healthcare institution's on-site and/or off-site information systems. In another embodiment, a database would monitor the flow of ADT (ADMISSIONS, Transfers, Discharge), diagnostic report and other messages through a healthcare institution's network by means of direct inspection of these data messages. In one embodiment, the messages are in the HL-7 format and can be decoded in accordance with the data format specification for HL-7. HL-7 is a set of standardized data formats for clinical data. http://www.hl7.org/implement/standards/ansiapproved.cfm, which is incorporated herein by reference (see FIG. 7). The standards are subject to the American National Standards Institute. Other messages that can be detected are messages to the patient themselves. Other data interchange formats can be used, including the Integrated Health Enterprise (IHE) protocols. Integrated Health Enterprise is another industry standardized interchange protocol which is recognized by practitioners in the art. Several profiles are presented at http://www.ihe.net/profiles/ (see FIG. 8) and the “Anatomic Pathology Technical Framework, Vol 1, Rev. 1.2, Nov. 24, 2008”, available at http://www.ihe.net/Technical_Framework/upload/ihe_anatomic-path_TF_rev1-2_TI_vol1_{—}2008-11-24.pdf which both of which are incorporated herein by reference.

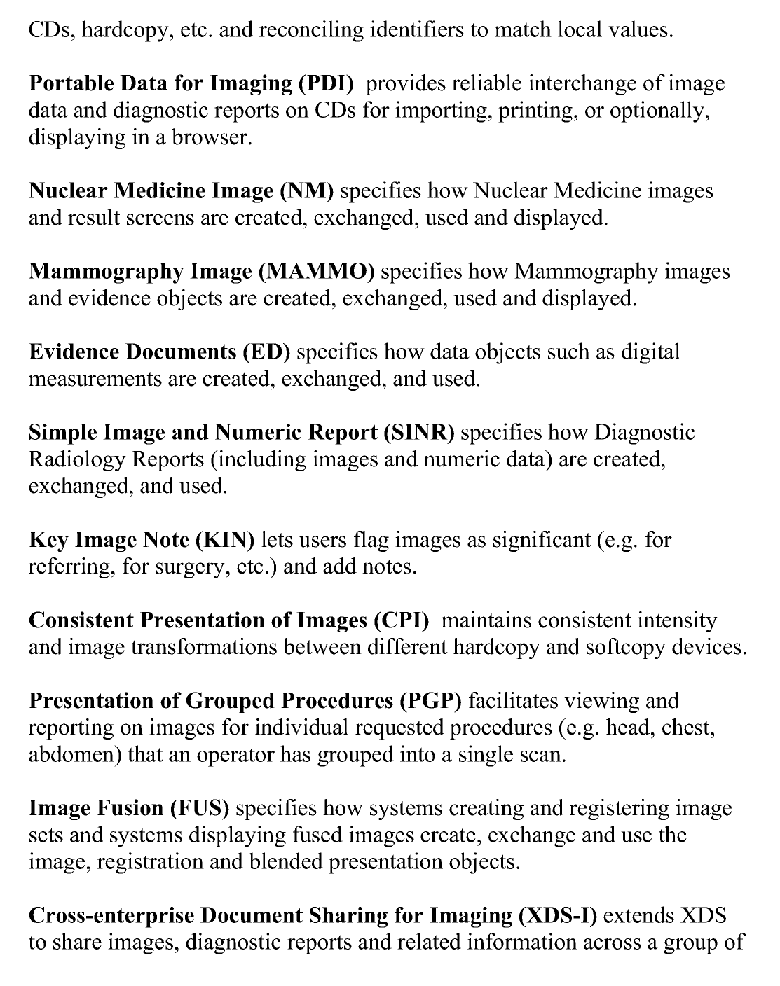

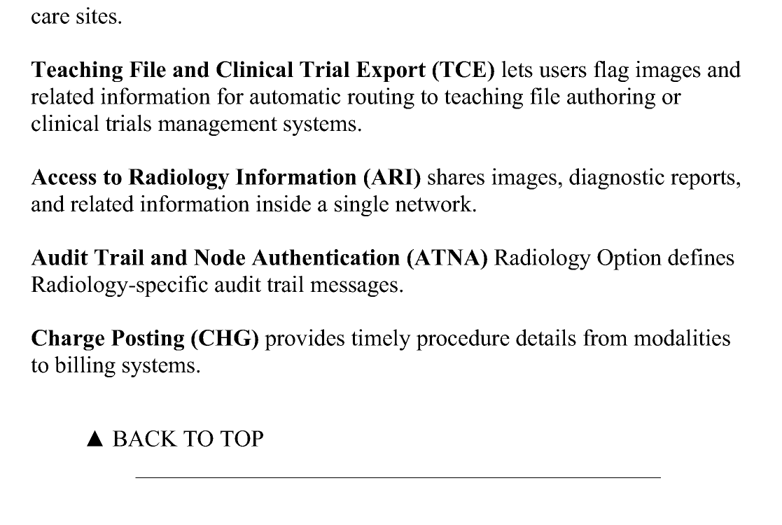

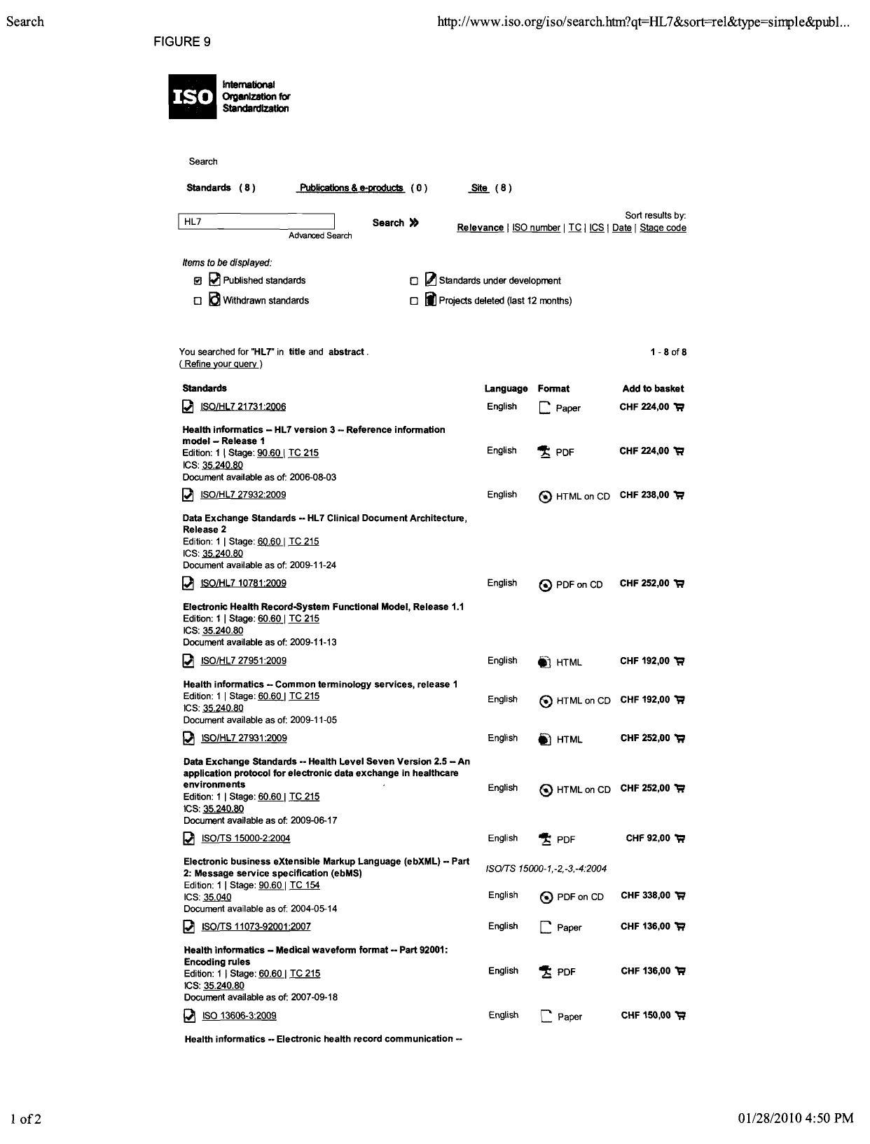

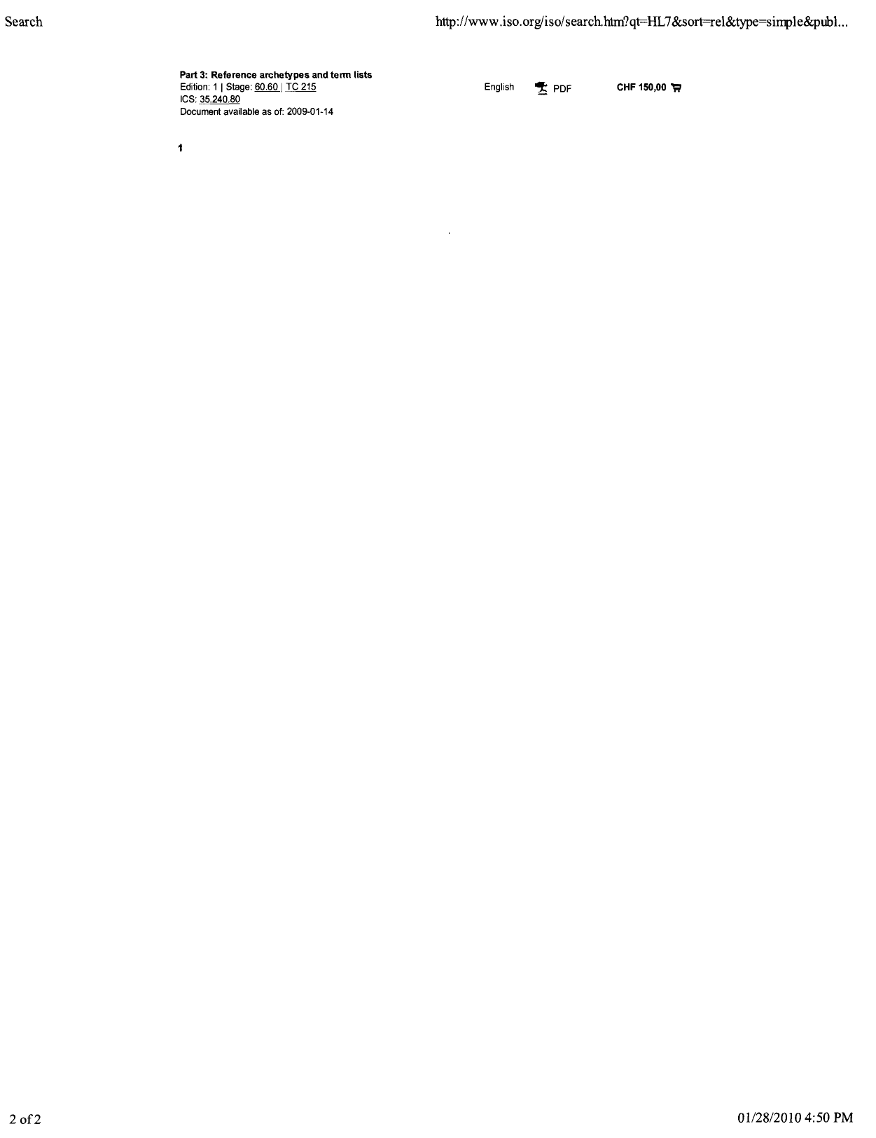

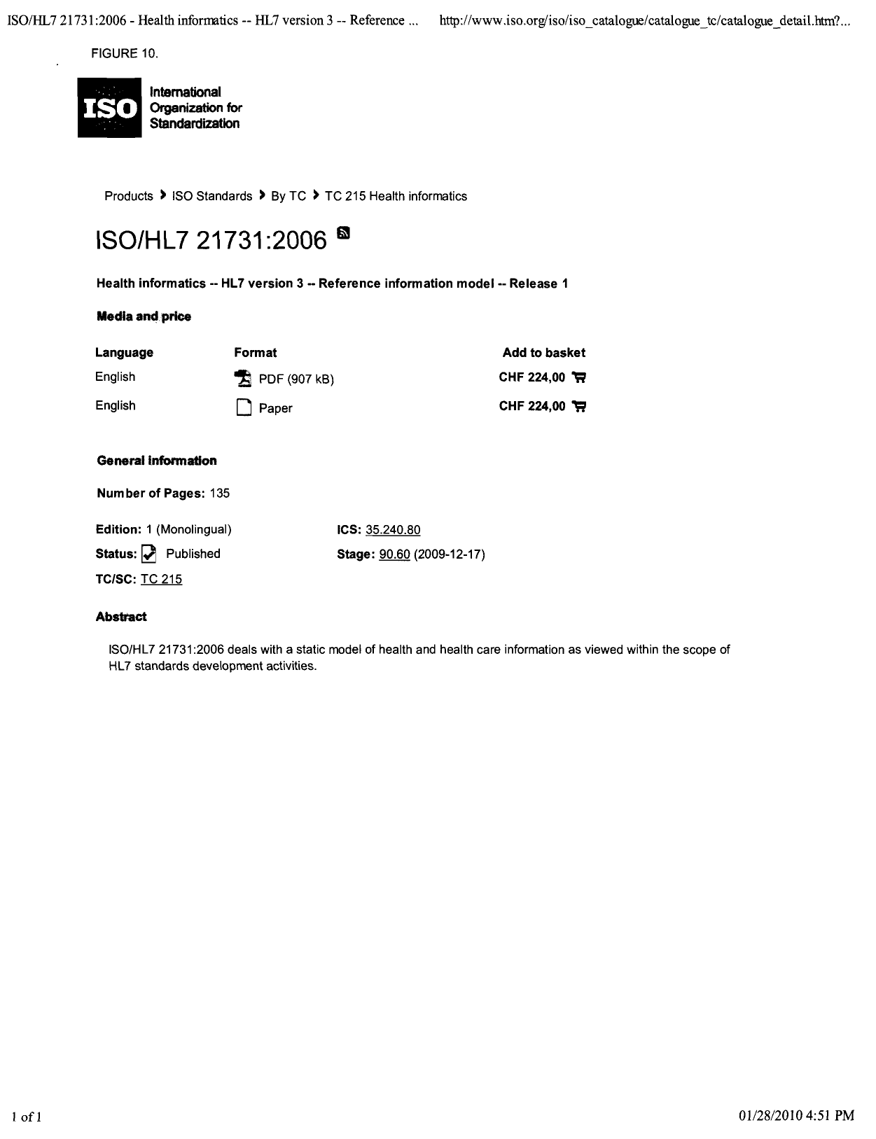

The HL-7 formats and protocols are generally available from the ISO organization, for example at:
http://www.iso.org/iso/search.htm?qt=HL7&sort=rel&type=simple&published=on (see FIG. 9)
http://www.iso.org/iso/iso_catalogue/catalogue_tc/catalogue_detail.htm?csnumber=40399 (see FIG. 10)

The system will comply with the requirements of the Health Insurance Portability and Accountability Act (HIPAA) and the Health Insurance Portability and Accountability Act (HIPPA) and the Healthcare Information Technology for Economic and Clinical Health Act (HITECH). One means of compliance is for the data that is provided to be scrubbed of any actual patient identity data in order that it be anonymous. In that embodiment, the patient data fields that are specified for patient name, address or social security number are deleted. In another embodiment, a patient serial number can be assigned that is a random number in order that a specific patient record be used individually, but without any known mapping from the patient name to the random number, sometimes referred to as “aliasing”.
2. Create data references in a database to link to information regarding every patient encounter (i.e. procedure, admission, outpatient visit, or other type of encounter).
3. Create a database containing data records that document risk reduction activities (i.e. medication reconciliation, critical test result communication to medical staff or to patients, discharge instructions) residing in medical records. (i.e. paper charts, medical center or office Information System documents, emails, or other data messages). The conversion of reports residing in computer databases into documents is described in the open source system from the Mirza Kashif reference incorporated by reference above.
4. When necessary, use natural language engines or other heuristics or algorithms to analyze text to detect risk reduction activity. This may be accomplished by key word searching, key word frequencies, natural language parsing and other techniques. In one embodiment, the program holds a list of important groups of key words, where each group is relevant to a known subject and a frequency key where for a given group, a frequency of use of that member word is expected. The program then searches for all the key words in the text and tallies the frequency of use of the word in the text. Finally, the program performs a best-fit analysis to determine which group of keywords use frequency matches the closest or sufficiently matches as compared to a predetermined quality value for fit. This can be performed by linear regression or R square analysis or similar known methods of determining the quality of fit or correlation between two statistical results. The program then updates its database to indicate the text is relevant to the subject matter associated with that group. Additional heuristics may be applied to a group whereby two words in the group are frequently used in the same sentence. The measure would then be the number of times the one word appears in the same sentence as the other. This statistic can be used to improve the distinctiveness of word groupings. Where more than one group may appear relevant, the program can prompt a human user to specify the outcome. Another method would be to generate a list of critical findings from those test reports that resulted in notifications to the referring clinician, or were flagged as a critical test result, either via language within the report, or via database flag set by the diagnostic physician, staff, or equipment or a data flag set or data field entered in the message in accordance with a protocol.
5. Each record in the database in step 2 includes patient identifiers, physician identifiers, identifiers for other staff involved in the activity, the encounter number, date, time and other data.
6. Measure frequency, quantity, quality, or any other relevant aspect of one or more risk reduction activities that are documented in the health care institution's electronic databases. This can also be used to calculate a metric. The data can be stored in the database created in step 3.
7. For each healthcare provider or patient, obtain data from the database and use it to calculate a metric.
8. Send metric data or raw performance data to interested institution and/or agencies. Alternatively, the data may be used by the organization for management of systems and personnel. In this embodiment, the metric data or raw performance data is used by a system internally to report compliance statistics to clinical care managers.

In another embodiment, facility data can be accessed as follows:
a. Place a database server (i.e. a Google box) inside the facility to “crawl” through the facility's electronic health records and catalog treatment data into a database. This includes the “official” electronic medical record, as well as lab, radiology and other systems used to treat patents and store data.
b. Create a VPN tunnel enabling an external database to link to the facility's electronic records. The external database system can be used to determine, retrieve and store relevant performance data and calculate metrics.
   In another embodiment, additional metrics can be determined, calculated and used:
Incidence of check list use: For every central line placed, how often did the staff follow the procedure checklist to reduce the incidence of infections.
How often did the facility provide discharge instructions to the patients?
For critical results, how often did the staff at the facility communicate the results directly to the patient or to the referring physician.
8. Another embodiment would be to create a health risk data network to transmit the status, conduct or completion of risk reduction activity to health care providers or health insurance companies. The data network interfaces with exercise machines, blood glucose meters, yoga studios and home motion detectors (for detecting patient ambulation, to assess risk for falls). In one embodiment, the exercise device or other therapeutic device has a card reader that the patient uses to swipe a personal key card through. By means of the card, the machine now has a patient identifying number. This number may or may not be identical to the patient's identifying number in the health provider's system. If not, then the system will have a database that maps the key card numbers to patient identifiers in the system. In any case, the therapeutic device can transmit usage data to the health care provider, or the health insurer in a secure manner that also includes the patient identifier on the key card so that the destination system can properly use the data to update the patient's activity status in a database. In another embodiment, the therapeutic device can have a keyboard interface and a screen. The patient can log into the machine by typing their name and a password or other pass-key number. The therapeutic device can then transmit these to the health care system for verification. The healthcare system can check that the patient name and key code match by looking in the patient database for the patient's database record. When confirmation is received by the therapeutic device, the device can now formulate the appropriate data message containing usage data by the patient to the healthcare system.

These types of metrics can be numerically calculated in a variety of ways. In one embodiment, the number of procedure checklists that are cited can be divided by the number of procedures of the same type to determine a percentage. Similarly, the denominator can be the total number of procedures of all types. The denominator can be determined based on a pre-determined amount of time for example, procedures during a particular week, month, quarter or year. In another embodiment, the metric can indicate frequency, for example the average rate of discharge instructions being cited in the EMR data as compared to the rate of discharges during the same time period. In another embodiment, the system can calculate the frequency of facility communications of test results as compared to the frequency of tests conducted. The frequencies can be determined on a time period basis. In addition, the frequencies can be determined by examining the same class of test or the same category of intended message recipient. Healthcare providers may be benchmarked against similar specialists practicing in similar settings.

In another embodiment, with regard to out-patient monitoring, the system can retrieve usage data from devices that are delivering therapy to the patient. For example, the computer in a treadmill can be accessed to retrieve usage data of the treadmill, including start times, stop times, average speeds, and inclination. In another embodiment, the computer in the device can, when the device is stopped, transmit to the system this data. In this embodiment, the treadmill, or similar therapeutic device, has a computer processor and sensors that detect the device usage. The computer processor periodically or on an incidental basis retrieves and stores the sensor data. The computer processor is operatively connected to a data network that accesses a wider network, that may include the Internet. When the computer processor transmits usage data to the system, it retrieves the sensor data from storage, formats the data into a message and transmits the message as a data transmission on the data network. The computer processor may have a unique identifier that distinguishes it in the system from other similar processors. The system maintains in a database the relevant usage data and associates that data with a patient by mapping the computer processor identifies with the patient identifier. Other therapeutic devices that can be monitored include weight scales, stationary bicycles, rowing machines, other exercise machines, breathing devices, insulin delivery devices, cardiac monitoring devices, blood pressure monitoring devices, insulin monitoring devices and other sensors.

The SaferMD system is designed to provide reliable practice activity data that insurance carriers and interested certification agencies can use to assess practitioners and facilities. One of the concerns is that diagnostic messages are either late, not picked up on a timely basis or not transmitted at all. Therefore, there is a need to check the timing of data interchange to track whether the data in the system is dependable from a risk assessment standpoint. Consider the following example, on Jan. 13, 2010, a diagnostic physician interprets a diagnostic imaging exam and notices an abnormal test finding. He fails to appropriately communicate the finding to the patient's physician. On May 1, 2010, the diagnostic physician learns that, as a result of his failure to communicate the result, the patient's physician failed to diagnosis and treat a serious condition, and that the condition has worsened. Fearing a malpractice liability lawsuit, the diagnostic clinician might be tempted to create false documentation that he did communicate the abnormal test result at the time of exam on Jan. 13, 2010. If the data record of the Jan. 13, 2010 communication is sent to the CTRM monitor database on May 1, the system could flag it as suspicious, or reject the data. In this case the system checks the cited date in the data record with the date of the actual change in the database.

The System will use the following techniques to assess the reliability of the data received:

Periodic or Data Transfers—The system will execute periodic data transfers, in one embodiment, a daily data transfer, by and among the facility, practitioner, 3rd party service provider, or other source of practice data. This precludes retrospective manipulation of data. That is because the data being used to monitor physician activity becomes off-limits by the end of the day. In another embodiment, the data transferred hourly.

System operators could adjust the system's time tolerance interval (i.e. 1 minute versus 1 day, or 1 month). This would enable them to calibrate the system's rejection parameters to the data transfer interval.

Test Data against Business Rules—The practice data transferred into the CTRM Monitor system reflects normal practice patterns. For example, a notification of an abnormal diagnostic test result is sent at a given time. The time stamp is time data that the system inserts into the data structure or data record constituting the message, without physician adjustment, rather than data input by the physician. Sometime later, a clinician retrieves the abnormal test result message from the system. This can result in an additional time stamp inserted into the data record. The event time stamps in the data will be checked against certain logic based on expected sequencing and time tolerance intervals. If the message retrieval time is earlier than the notification time, the system could flag the data record as suspicious, or reject it.

Normative Data—The system could trend practice activity by type of practitioner and practice setting. For example, the system could determine the median number of abnormal test result messages generated by neuroradiologists in urban academic hospitals. The system could use statistical tests (i.e 95% confidence intervals) to determine if the practice pattern of a given practitioner is significantly different from those of most similar practitioners.

### Data Testing

Insurers and other interested parties rely on data from this system that demonstrates clinical activity that precludes or reduces risk of certain types of medical misadventures. This module is designed to confirm the reliability of the clinical data provided. The system is designed to detect false documentation. This could arise from deliberate data manipulation, technical error, data corruption, or other causes. Any interested stake holder may be interested in manipulating the clinical or CTRM data. These include (but are not limited to): the diagnostic physician (or lab), the receiving clinician, and the healthcare facility.

In the case of abnormal test result notification, the community standard requires the diagnostic physician to communicate directly to the referring clinician. The normal sequence of events are:
(1) Diagnostic physician interprets exam and identifies abnormal finding
(2) Diagnostic physician communicates the abnormal test results to the referring clinician
   The data elements typically required to document appropriate notification are:
1—Date/Time of notification of abnormal or emergent test result
2—Content of notification
3—Identify the clinician that received the notification
4—Date/Time clinician obtained the notification

Alternatively, the diagnostic physician can use a Critical Test Results Management (CTRM) system to deliver the notification. When using a CTRM system, the diagnostic physician creates a message containing the abnormal test result that is recorded in the system, one embodiment of the system records time stamps when:
(a) Message Creation: The Diagnostic physician creates the abnormal test result notification
(b) Notification: The system sends notification that there is an abnormal test result to the referring clinician
(c) Repeat Notification: If the referring clinician fails to retrieve the message after the first notification, the CTRM system sends a repeat notification.
(d) Notification Escalation: If the referring clinician fails to retrieve the abnormal test result message within a specified compliance interval (the length of the compliance interval depends on the urgency category of the message), the system escalates the message to a backup physician.
(e) Message Retrieval: the referring clinician accesses the CTRM system to retrieve the abnormal test result message.
(f) Message Retrieval Completion: the referring clinician listens to the message in its entirety.
(g) Read Back: The referring clinician repeats the message in order to document that she understands the finding.
(h) Return message: the referring clinician may elect to send a message back to the diagnostic clinician.

Each of these events may be documented as data in the diagnostic procedure report, or in a database that documents notifications of abnormal test results. In one embodiment, the database could reside in the electronic medical record or at the CTRM service vendor. In another embodiment, the event time stamps are data records in a relational database that are linked to the EMR or linked to the diagnostic reports themselves. These data records may be stored in a separate server housed under the control of the monitoring system provider. In another embodiment, the data may be obtained by query of an electronic medical record (EMR). For example, the system may analyze radiology reports in the EMR to determine if the report has been finalized and to detect documentation of abnormal test result notification. Once the report is finalized, a data record is created, identified with a unique serial number. The sequence of events of the abnormal test result notification (or lack thereof) are recorded in the database record for that report.

Certifying/ratings agencies and liability insurance carriers need reliable data in order to appraise the practitioner and /or healthcare facility. The DATA TESTER module of the system evaluates the reliability of database records that document critical test result notification and message retrievals. The system is designed to access or import documentation of abnormal test result notification and other relevant data into a database. The system imports data from multiple sources: for example, CTRM services, electronic health records (EMR), as well as paper medical records that can either be scanned with optical character recognition systems known in the art or the data hand entered. The latter requires manual data entry.

Each abnormal test result can be identified with a unique number. That ID # may be associated with one or several database records of notifications containing time stamps.

In one illustrative embodiment:

| Abnormal | Notification | | | Retrieval | Retrieval |
|---|---|---|---|---|---|
| Test Result # | Time/Date | Sender | Recipient | Time/Date | Completion |
| 00001 | Jan. 21, 2010 09:35 | Nelson | Zamboni | — | |
| 00001 | Jan. 21, 2010 09:40 | Nelson | Zamboni | — | |
| 00001 | Jan. 21, 2010 09:45 | Nelson | Zamboni | — | |
| 00001 | Jan. 21, 2010 09:50 | Nelson | Gibbons | Jan. 21, 2010 09:52 | Jan. 22, 2010 12:10 |
| 00001 | Jan. 21, 2010 09:55 | Nelson | Zamboni | — | |

In this case, Dr. Nelson used a CTRM system to send the original notification of Abnormal Test Result #1 on 1/21/10@09:35. The system sent the first notification at 9:35. With no response, the CTRM system sent additional notifications every 5 minutes, and then escalated the notification to Dr. Gibbons. Dr. Gibbons answered the message immediately. After that, the system stopped sending notifications. Dr Gibbons started to listen at 9:52 but didn't complete listening to the entire message until 12:10.

There are several scenarios in which the database record documenting abnormal test result notification could be false. Some of these data relationships go beyond CTRM. These scenarios involve the relationship between events documented in the medical record (i.e. in progress notes). These may documented in the electronic medical record (EMR), using DICOM, HL7 W3C and other medical data interchange standard formats, subject to security restrictions. The Data Tester applies one or more data integrity rules against the notification record(s). If the time stamps and other data are inconsistent with the rules, the notification record is flagged as suspicious. Several exemplary rules are presented below.

Delayed Test Order (Request): Clinician examines patient, but fails to request the diagnostic exam in a timely manner, i.e. within a maximum period of time. Data Tester compares clinical visit date/time to diagnostic procedure order and performance time. If the time intervals are longer than a pre-defined compliance interval, the record is flagged as suspicious. Application of the rule checks whether an diagnostic examination is ordered by the clinical physician after the diagnosis was already known and entered into the record: A diagnosis is known to the referring clinician. She orders a diagnostic test in an attempt to create a false documentation that the diagnosis became apparent after the new diagnostic procedure. The Data Tester compares the Electronic Medical Record documentation of the abnormal diagnosis to the date/time the diagnostic exam was ordered. If the time stamp associated with the exam order comes after the diagnosis itself was entered into the EMR, the record is flagged as suspicious.

Delayed Test Interpretation: In this case, a diagnostic test is performed in a timely manner, but there is a delay in interpretation. The system compares the time stamps associated with the procedure date/time and the report date/time to the notification date/time. Depending on the severity of the diagnosis, if the notification interval surpasses a compliance interval, the record is flagged as suspicious. The system will classify families of diagnoses with a ranges of pre-determined interval thresholds. When the test is conducted, the type of diagnostic test is extracted from the data record and then mapped to the appropriate time interval threshold to apply as the test.

Delayed Notification of Abnormal Result: In this case, the Diagnostic clinician interprets the diagnostic procedure, but fails to communicate the abnormal test result. Months later, she learns that the patient was harmed because of a failure or delay in diagnosis. At that time, she sends notification to the referring clinician. The Data Tester compares the time stamps associated with the procedure date/time and report date/time to the notification date/time. Depending on the severity of the diagnosis, if the notification interval surpasses a compliance interval, the record is flagged as suspicious. When the test is conducted, the type of diagnostic test is extracted from the data record and then mapped to the appropriate time interval threshold to apply as the test.

Fabricated Documentation: In this case, the Diagnostic clinician fails to communicate abnormal test result. Diagnostic physician enters back dated, false documentation of abnormal test result notification into the database. The Data Tester compares abnormal result serial number and the date record was created in database to the report date. If the notification record was created after the report date, or if the notification record ID # is out of sequence, the record is flagged as suspicious. In one embodiment, the system automatically tags the creation date of each of the report data record and the notification record. This data is not alterable by the users of the system. In another embodiment, the numerical identifiers associated with a patient are issued in a pre-determined sequence. In one embodiment, a first predetermined set of digits of in the number identify the patient and a second predetermined set of digits identify the order of action in the patient diagnostic process. These numbers are not changeable by the system users, rather, they are typically generated automatically by the system itself.

Delayed retrieval of test result message: In this scenario, the Data Tester determines how long it took for the clinical physician to retrieve the notification, or the retrieval interval. If interval is prolonged, record is flagged as suspicious. In this case, the Diagnostic Physician sends notification, but the Clinical Physician fails to retrieve message within a pre-determined time interval threshold. As a result the Electronic Medical Record is flagged as suspicious.

In another case, the DP Sends notification, CP fails to retrieve message, but the data record later changes to indicate message was retrieved on time. Since the data record was previously retrieved any “after the fact” change would suggest documentation tampering. Record would be flagged as suspicious.

Corruption of EMR data: This can result in several suspicious data elements. One logic rule tests: for example, is the physician's name known to the system as being associated with the system, or the patient or the clinician or the diagnostician?

Sequence Rule Compliance: For this case a logic rule tests: Do the time stamps for the sequential events of an abnormal test result notification appear in the correct sequence? The system will confirm that the notification time stamp occurs before the message retrieval time stamp.

In another embodiment, diagnostic equipment can automatically transmit usage data to the monitoring system. For example in the case of radiological imaging or radiation treatment equipment, the system can automatically track how much radiation dosage was received by a patient and insert that data into the patient's EMR or other database record. In one embodiment a CT scanner may record data representing the amount of radiation dose in the DICOM image header and/or the HL7 procedure order message. These may both be collected in a database on site or remotely, as part of a record corresponding to each procedure. Other fields in the data record may include: date, time and type of procedure, patient age, patient weight, patient body habitus. These doses can be numerically compared by the equipment to typical doses given the procedure type and patient characteristics by comparing the stored dosage data with a predetermined normative threshold value stored elsewhere in the system. The data can also be used as a basis for statistical sampling of use of radiological diagnoses, with a variety of bases in order to come up with baseline threshold values. In one embodiment, the system will use typical database query methodologies to tabulate all of the dosages for a particular body part. This may be further filtered by patient sex, weight habitus or other characteristics. Then, the system can calculate an average, a mean or other value that can be used as the predetermined comparison threshold for that situation. In another embodiment, the predetermined threshold is input into the system and stored as a value. The system can then automatically check whether any patient has received too much of a dosage compared to the determined or input normative predetermined threshold for that body part, or, that body part and other patient factors, for example, weight range, sex habitus and the like.

The degree of compliance can be transmitted to insurers and other interested parties to evaluate risk of giving a radiation overdose. In one embodiment, the mechanism to report is outlined as follows: the radiation diagnostic or treatment device uses a field in the HL7 message stream to indicate the dose of radiation. The HL7 message is directed to a system server (which may be in addition to the hospital information system). In another embodiment, a message is transmitted directly to the primary physician or other person responsible for treating or dealing with radiation overdoses.

In another embodiment, a dedicated monitoring computer is operatively connected locally to the diagnostic device or other radiation producing device. This unit interfaces with the treatment devices dose calculator and/or dose database. The monitoring unit, or the HL7 server sends treatment data in the form of database records to the main system database.

Each record in the database corresponds to a patient treatment session. In this case, the system will record the day/time of the dose, patient name, or identifying number, anonomized or not, diagnosis (by name), dx (ICD9 or ICD10 code), body part treated, dose, duration of dose (given over how much time), cumulative dose to that body part, cumulative dose to the patient. Each treatment session corresponds to another data record.

The system would populate a database that would include patient treatments and total doses. The treatments may be statistically analyzed against typical treatment plans for the body part and diagnosis. The system also develops normative data for treatment plans for the body part and diagnosis. In another embodiment, the system could allow patients to access their accumulated radiation dose records.

The system offers alarms when usual doses are exceeded, and statistics on compliance with norms. When the system detects a dosage above the predetermined threshold, for example, upon storing a session record, the system can make a numerical comparison of the dosage data present in the record to be stored with the normative threshold. If exceeded, the system can the query the identity of the primary care physician. At that point, the system can formulate a data message to the physician that includes the patient identifier and indicates a radiation dosage alarm. This data message can then be transmitted via the data network to the primary care physician, either as an HL7 message, email, text or other electronic data transmission.

By “send” it is meant that a data message is formulated and transmitted by digital data networks to a computer operated by or on behalf of a clinician or diagnostician or other party. For example, when an abnormal test result is entered into the system, the system can send an email to a designated email address associated with the clinical physician. The logic rules are applied by first querying the relevant data in the patient data record or retrieving it by parsing the data message. The computer program executing the logic rule then compares that one or more data values to one or more other retrieved data values to return a logical or numerical result. This value may then used by the program to cause, in appropriate cases, a change in program logic that results in the system causing a data message being transmitted. Statistical analysis is performed by applying a database query to obtain one or more relevant data values from data records that meet the query requirement. These data values can be organized as a table that is stored as a data structure in a computer. The data structure may by parsed and the data values input into calculations that produce mean, average, standard deviation and similar statistical measures for the sample values.

In another embodiment, diagnostic equipment rather than exercise equipment can automatically transmit usage data to the monitoring system. For example in the case of radiological imaging or radiation treatment equipment, the system can automatically track how much radiation dosage was received by a patient and insert that data into the patient's EMR or other database. In one embodiment a CT scanners may record data representing the amount of radiation dose in the DICOM image header and/or the HL7 procedure order message. These may both be collected in a database on site or remotely, as part of a record corresponding to each procedure. Other fields in the data record may include: date, time and type of procedure, patient age, patient weight, patient body habitus. These doses can be numerically compared by the equipment to typical doses given the procedure type and patient characteristics by comparing the stored dosage data with a predetermined normative threshold value stored elsewhere in the system. The data can also be used as a basis for statistical sampling of use of radiological diagnoses, with a variety of basis in order to come up with baseline threshold values. In one embodiment, the system will use typical database query methodologies to tabulate all of the dosages for a particular body part. This may be further filtered by patient sex, weight or other characteristics. Then, the system can calculate an average, a mean or other value that can be used as the predetermined comparison threshold. In another embodiment, the predetermined threshold is input into the system and stored as a value. The system can then automatically check whether any patient has received too much of a dosage compared to the determined or input normative predetermined threshold for that body part, or, that body part and other patient factors, for example, weight range, sex and the like.

The degree of compliance can be transmitted to insurers and other interested parties to evaluate risk of giving a radiation overdose. In one embodiment, the mechanism to report is outlined as follows: the radiation treatment device uses a field in the HL7 message stream to indicate the dose of radiation. The HL7 message is directed to a system server (which may be in addition to the hospital information system). In another embodiment, a message is transmitted directly to the primary physician or other person responsible for treating or dealing with radiation overdoses.

In another embodiment, a dedicated monitoring computer is operatively connected locally to the diagnostic device or other radiation producing device. This unit interfaces with the diagnostic or treatment devices dose calculator and/or dose database. The monitoring unit, or the HL7 server sends treatment data in the form of database records to the main system database.

Each record in the database corresponds to a patient scan or treatment session. In this case, the system will record the day/time of the dose, patient name, or identifying number, anonymized or not, diagnosis (by name), dx (ICD9 code), body part treated, dose, duration of dose (given over how much time), cumulative dose to that body part, cumulative dose to the patient. Each diagnostic scan or treatment session corresponds to another data record.

The system would populate a database that would include patient scan or treatments and total doses. For radio-therapy, the treatments may be analyzed against typical treatment plans for the body part and diagnosis. The system also develops normative data for treatment plans and diagnostic radiation doses for the body part and diagnosis.

The system offers alarms when usual doses are exceeded, and statistics on compliance with norms. When the system detects a dosage above the predetermined threshold, for example, upon storing a session record, the system can make a numerical comparison of the dosage data present in the record to be stored with the normative threshold. If exceeded, the system can the query the identity of the primary care physician. At that point, the system can formulate a data message to the physician that includes the patient identifier and indicates a radiation dosage alarm. This data message can then be transmitted via the data network to diagnostic physician, radiation therapist or the primary care or other physician, either as an HL7 message, email, text or other electronic data transmission.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server or computer may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet or other data networks using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. Practitioners of ordinary skill will recognize that the data entries in the data packet may be address pointers to the actual data rather than the data themselves, that is, a communication between processes may provide the receiving computer an address pointer that tells the computer where to find the data representing the item, rather than providing the data item itself.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention.

Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.
The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)
The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques, the overall results or otherwise departing from the true scope of the invention. The spirit and scope of the present invention are to be limited only by the terms of the appended claims.

What is claimed:

1. A system comprising a diagnostic or therapeutic device comprising a computer processor, operatively connected to a database, where the diagnostic or therapeutic device transmits usage data to the database and the database stores the usage data in association with a patient identifier value, where the computer processor is adapted to check the usage data against a pre-determined standard value of usage associated with the type of diagnostic or therapeutic device.

2. A method of measuring risk reduction activities comprised of receiving data containing patient encounter information, storing said data, calculating one or more metrics for the frequency, quantity, quality, or any other relevant aspect of one or more corresponding risk reduction activities that are documented in the data, and storing the one or more calculated metrics.

3. The method of claim 2 further comprising comparing the calculated metrics to one or more corresponding pre-determined standard values associated with such corresponding one or more risk reduction activities.

4. A method of measuring risk reduction activities comprised of receiving data associated with one or more reportable medical result notifications, storing said data, calculating a metric for the frequency, quantity, quality, or any other relevant aspect of one or more risk reduction activities that are documented in the data, storing the one or more metrics.

5. The method of measuring risk reduction activities of claim 4 further comprising: where the metric is an integrity test to verify that the actions of users of a medical report result notification monitoring system meet a pre-determined rule.

6. The method of claim 5 where the rule is a test that sufficient percentage of notifications were retrieved by the intended recipient within a pre-determined amount of time.

7. A method of measuring risk reduction activities comprising the steps of:
Retrieving from data storage data representing medical communication messages;
Converting the received data into data representing reportable medical reportable result communication messages;
Calculating the proportion of the reportable result messages that the reporting physician communicated to the referring clinician; and
Storing the calculation result.

8. The method of claim 7 further comprising the step of generating a report that indicates for each reporting physician, the proportion of reportable result messages containing notification documentation.

9. The method of claim 7 further comprising generating a data file embodying a report that indicates for each referring clinician, the proportion of reportable result messages that they retrieved.

10. The method of claim 7 further comprising generating a data file embodying a report that indicates for each referring clinician, the proportion of reportable result messages sent that they acted upon.

11. A method of measuring risk reduction activities comprising the steps of:
Storing a database record representing each admission, transfer or discharge and a patient identifier associated therewith;
Calculating for a predetermined set of such database records the proportion that had medication reconciliation performed by the caregiver.

12. The method of claim 11 further comprising the step of comparing the calculated proportion is to a predetermined rate.

13. A method of measuring risk reduction activities comprising the steps of:
Creating a database comprised of data records that correspond to a plurality of patient encounters;
Determining which of the data records document one or more pre-determined risk reduction activities;
Calculating from the determined data records one or more metrics corresponding to the pre-determined risk reduction activities.

14. The method of claim 13 where the metric is one of: frequency, quantity or quality of the risk reduction activity.

15. A method of measuring risk reduction activities comprising:
Receiving data representing communication activity regarding reportable medical result notification between two of a referring physician, a diagnostic physician and a patient;
Determining at least one message condition for each notification;
Storing said message condition.

16. The method of claim 15 where the message condition is one of: the number of repeat notifications, a notification escalation, the time to retrieve the notification, the time to complete retrieval and review of the notification, a read back occurred, a return message was sent.

17. The method of claim 16 further comprising:
Checking the message condition data to determine if a pre-determined integrity test has failed.

18. The method of claim 17 where the integrity test is a test for one of: A delayed test order, a delayed test interpretation, a delayed notification of abnormal result, fabricated documentation, delayed retrieval of a message, corruption of EMR data, sequence rule compliance.

19. The method of claim 18 where the integrity test is a statistical result for a plurality of communications that is compared to a predetermined normative value.

20. A system comprised of one or more computers operatively connected over a data network adapted to perform any of the methods of claims 2 through 19.

21. A computer readable medium comprising data, where said data represent executable code that when executed on a computer causes the computer to execute any of claims 2 through 19.
